(19) United States
(12) Patent Application Publication
(10) Pub. No.: US 2023/0397706 A1
(43) Pub. Date: Dec. 14, 2023

(54) HAIRCARE APPLIANCE

(71) Applicant: Dyson Technology Limited, Wiltshire (GB)

(72) Inventor: Samuel Michael John FORD, Bristol (GB)

(73) Assignee: Dyson Technology Limited, Wiltshire (GB)

(21) Appl. No.: 18/034,685

(22) PCT Filed: Oct. 13, 2021
(86) PCT No.: PCT/GB2021/052642

§ 371 Date: Apr. 29, 2023

(30) Foreign Application Priority Data
Nov. 2, 2020 (GB) 2017305.0

(51) Int. Cl. A45D 20/12; H05B 1/02; G06T 7/70

(52) U.S. Cl. CPC A45D 20/12; H05B 1/0252; G06T 7/70; A45D 2200/205; G06T 2207/30196; G06T 2207/10048

(57) ABSTRACT

A haircare appliance has a heat source configured to emit heat, a location determination module configured to determine a location of target hair, and a guide mechanism for use in guiding emitted heat from the heat source to the location of the target hair in response to an output of the location determination module.

### FIELD OF THE INVENTION

The present invention relates to a haircare appliance.

### BACKGROUND OF THE INVENTION

Hair dryers typically utilise convective heating to heat airflow that is used to dry hair. Hair dryers that utilise other techniques for drying hair have been proposed, including hairdryers that use infrared radiation to dry hair.

### SUMMARY OF THE INVENTION

According to a first aspect of the present invention there is provided a haircare appliance comprising a heat source configured to emit heat, a location determination module configured to determine a location of target hair, and a guide mechanism for use in guiding emitted heat from the heat source to the location of the target hair in response to an output of the location determination module.

The haircare appliance according to the first aspect of the present invention may be advantageous as the location determination module determines a location of target hair, and the guide mechanism enables guiding of emitted heat from the heat source to the location of the target hair. In such a manner emitted heat from the heat source may be guided to the location of the target hair, which may provide more efficient drying with less wasted power than, for example, a haircare appliance where heat is simply directed in the general vicinity of hair by motion of the haircare appliance by a user.

The guide mechanism may comprise a movable member movable in response to the output of the location determination module. For example, the haircare appliance may comprise a controller that controls movement of the movable member in response to the output of the location determination module. A movable member may provide a simple mechanical guiding mechanism which may be relatively low cost.

The guide mechanism may be configured to provide a visual and/or aural indicia to a user, for example a visual and/or aural indicia that directs a user to move the haircare appliance such that heat from the heat source is guided toward the location of target hair, in response to the output of the location determination module. The guide mechanism may comprise any of a light, a display, or a speaker.

The heat source may comprise an infrared emitter configured to emit infrared radiation. This may provide more efficient heating than, for example, a convective heat source which is required to heat airflow output by a haircare appliance.

The guide mechanism may comprise an optical element configured to interact with infrared radiation emitted by the infrared emitter. Such an optical element may be used to guide infrared radiation to the target location.

The infrared emitter may be configured to emit infrared radiation in a first direction, and the optical element may be configured to interact with the emitted infrared radiation such that infrared radiation downstream of the optical element travels in a second direction different to the first direction. The optical element may be configured to reflect the infrared radiation.

The optical element may comprise a plurality of mirrors. A plurality of mirrors may provide a simple guide element that reflects emitted infrared emission toward the location of target hair. The optical element may comprise an array of mirrors, each mirror selectively movable in response to the output of the location determination module to guide the emitted infrared radiation to the location of target hair. This may provide enhance control over the directionality of infrared radiation emitted from the haircare appliance.

The heat source may comprise a laser light source, for example an infrared laser light source. A laser light source may comprise a relatively high-powered infrared emitter, and so may provide increased drying efficiency compared to, for example, a convective heat source. However, laser light sources may be harmful to, for example, the eyes of a user. By using the location determine module and the guide mechanism to guide infrared radiation emitted by the laser light source only to the location of target hair a safe appliance that utilises a laser light source may be provided.

The optical element may comprise a microoptoelectromechanical system, for example a digital micromirror device such as a DLP chip. This may be beneficial as any stray infrared radiation reflected by a pixel of the DLP chip may be a relatively small proportion of the full beam of infrared radiation, and hence may be relatively low powered.

The guide mechanism may be configured to perform a projection mapping operation to guide the emitted infrared radiation to the location of target hair.

The optical element may comprise a first mirror rotatable about a first axis, and a second mirror rotatable about a second axis substantially orthogonal to the first axis. The guide mechanism may comprise first and second motors or galvanometers for rotating a respective one of the first and second mirrors. Such an arrangement of mirrors may be advantageous where, for example, the infrared emitter comprises a scanning laser.

The haircare appliance may comprise a further optical element, the further optical element configured to refract the infrared radiation. The further optical element may be configured to focus or defocus the infrared radiation. The further optical element may be configured to reduce a power level of the infrared radiation. The further optical element may comprise a lens or a series of lenses. The further optical element may be located upstream and/or downstream of the optical element.

The location determination module may be configured to map the location of target hair, for example to determine a boundary corresponding to a boundary of target hair to be dried.

The location determination module may comprise an imaging sensor configured to capture an image, and an image processor configured to determine the location of the target hair within the captured image. An imaging sensor may enable accurate determination of the location of target hair.

The imaging sensor may comprise a thermal imaging sensor. Wet hair may typically be cooler than dry hair, and so use of a thermal imaging sensor may enable determination of the location of wet hair to be dried by the haircare appliance.

The imaging sensor may comprise a visible light imaging sensor, for example a camera. The location determination module may comprise an image classifier for determining target hair, for example wet hair, within an image captured by the visible light imaging sensor. Use of a visible light imaging sensor may enable more accurate determination of the location of target hair where a moisture content of target hair is relatively low, and hence closer in temperature to dry hair.

The location determination module may comprise a hair sensor configured to determine a property of hair, and the location determination module may be configured to process an output of the hair sensor to determine the location of the target hair. Use of hair properties by the location determination module may enable greater accuracy in determination of the location of target hair.

The hair sensor may comprise a temperature sensor for sensing a surface temperature of hair. Hair may be cooler when it is wet, and so use of a temperature sensor may enable correct determination of the location of target hair, for example hair to be dried.

The hair sensor may comprise a moisture sensor for sensing a moisture level of hair. This may enable correct determination of the location of target hair, for example hair to be dried.

The haircare appliance may comprise a controller configured to control the heat source in response to an output of the hair sensor or an output of the location determination module. For example, the controller may be configured to increase or decrease a temperature of the heat source in response to an output of the hair sensor or an output of the location determination module. This may enable automatic temperature control, for example where the hair sensor indicates dry hair, or where the location determination module is unable to locate hair to be dried. The heat source may be configured to be inoperable when the location determination module cannot determine a location of target hair.

The haircare appliance may comprise an airflow generator configured to generate an airflow directed toward the determined location of target hair. This may increase efficiency of drying and reduce drying time, for example by blowing away evaporated liquid from the vicinity of the location of target hair.

The haircare appliance may comprise a main body, and an attachment releasably attached to the main body, the attachment comprising any of the heat source, the location determination module, or the guide mechanism. The attachment may comprise a power source for powering any of the heat source, the location determination module, or the guide mechanism. Provision of any of the heat source, the location determination module, or the guide mechanism may enable the functionality discussed herein to be retrofitted to an existing haircare appliance. The attachment may be configured to communicate with components housed within the main body, for example via a wired or wireless connection.

The haircare appliance may comprise a battery-operated haircare appliance.

According to a second aspect of the present invention there is provided an attachment for a haircare appliance, the attachment comprising a heat source configured to emit heat, a location determination module configured to determine a location of target hair, and a guide mechanism for use in guiding emitted heat from the heat source to the location of the target hair in response to an output of the location determination module.

The location determination module may comprise an imaging sensor configured to capture an image, and an image processor configured to determine the location of the target hair within the captured image, and the method may comprises obtaining an image via the imaging sensor, and processing the image to determine the location of the target hair.

Optional features of aspects of the present invention may be equally applied to other aspects of the present invention, wherein appropriate.

### BRIEF DESCRIPTION OF THE DRAWINGS

FIG. 1 is a schematic illustration of a haircare appliance according to the present invention;

FIG. 2 is a schematic illustration of a first embodiment of a guide mechanism for the haircare appliance of FIG. 1;

FIG. 3 is a schematic illustration of a second embodiment of a guide mechanism for the haircare appliance of FIG. 1;

FIG. 4 is a schematic illustration of a second embodiment of a haircare appliance according to the present invention;

FIG. 5 is a schematic illustration of a third embodiment of a haircare appliance according to the present invention; and

FIG. 6 is a schematic illustration of a fourth embodiment of a haircare appliance according to the present invention.

### DETAILED DESCRIPTION OF THE INVENTION

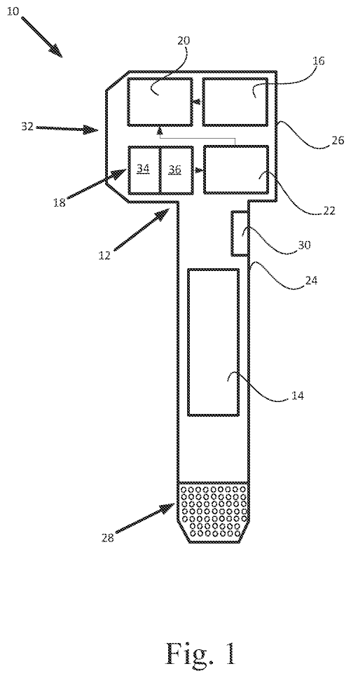

A haircare appliance, generally designated 10, according to the present invention is illustrated schematically in FIG. 1. In the embodiment of FIG. 1 the haircare appliance 10 has a hair dryer format, although it will be appreciated that other formats of haircare appliance may utilise the teachings discussed herein, including, for example, hair straighteners, hair stylers and the like. The haircare appliance 10 of FIG. 1 is intended to connect to an AC mains power supply via an appropriate electrical cable (not shown), but it will be appreciated that embodiments where the haircare appliance 10 comprises its own power source, for example its own battery, are also envisaged.

The haircare appliance 10 comprises a housing 12, an airflow generator 14, a heat source 16, a location determination module 18, a guide mechanism 20, and a controller 22.

The housing 12 comprises a handle portion 24 and a body portion 26. The handle portion 24 is generally tubular in form, and is hollow. The handle portion 24 comprises an air inlet 28, which takes the form of a plurality of apertures, and the handle portion 24 also houses the airflow generator 14. A user interface 30 is disposed on the handle portion 24, and comprises a plurality of user-actuable buttons and/or a touch-screen interface.

The body portion 26 is generally cylindrical in form, but is tapered toward an air outlet 32 of the haircare appliance 10, such that one end of the body portion 26 is generally frustoconical. The body portion 26 is hollow and houses the heat source 16, the location determination module 18, the guide mechanism 20 and the controller 22. The air outlet 32 may comprise a generally circular aperture, or in embodiments where the body portion 26 has a central bore then the air outlet 32 may be generally annular and disposed radially outwardly of the central bore.

The airflow generator 14 comprises a motor driven impeller to draw airflow into the housing 12 via the air inlet 28. An example of an appropriate airflow generator 14 is the Dyson® digital motor V9, produced by Dyson Technology Ltd. The airflow generator 14 generates an airflow from the air inlet 28 through the handle portion 24 and the body portion 26 to the air outlet 32 in use.

The heat source 16 is disposed in the body portion 26 of the housing 12, and comprises a laser light source configured to emit infrared radiation, for example having a wavelength in the region of 700 nm-1 mm. In some embodiments the laser light source is configured to emit infrared radiation having a peak wavelength in the region of 2000-3000 nm. The infrared radiation emitted by the laser light source is configured to interact with and dry hair in use.

The location determination module 18 includes a thermal imaging sensor 34 and a processor 36. The thermal imaging sensor 34 is configured to provide a thermal image of hair proximal to the haircare appliance 10, for example proximal to the air outlet 32, in use, and the processor 36 is configured to process the thermal image to determine a location of target hair within the thermal image. For example, hair that is relatively wet may have a lower surface temperature than hair that is relatively dry in view of its moisture content. The location determination module 18 may make use of this, with the processor 36 outputting a location of target hair, for example wet hair, to the controller 22.

Although shown here as part of the location determination module 18, it will be appreciated in practice that the processor 36 could also be part of the controller 22, or indeed that the controller 22 could be part of the location determination module 18.

The guide mechanism 20 is controlled by the controller 22 in response to the output of the location determination module 18 to direct heat from the heat source 16, in this case infrared radiation from the laser light source, toward the target hair. This may provide more efficient drying with less wasted power than, for example, a haircare appliance where heat is simply directed in the general vicinity of hair by motion of the haircare appliance by a user.

A first example of a possible guide mechanism 100 is illustrated schematically in FIG. 2.

Here the guide mechanism 20 comprises a digital light processing (DLP) chip 38, and first 40 and second 42 lenses. The DLP chip 38 includes a digital micromirror device, that is a microoptoelectromechanical system (MOEMS) including a large number, typically hundreds of thousands, of microscopic mirrors, each of which is rotatable. In use, the DLP chip 38 may be controlled in response to the output of the location determination module 18 such that each mirror can rotate to guide a “pixel” of infrared radiation emitted by the laser light source toward the target hair 44.

The first 40 and second 42 lenses refract infrared radiation reflected by the DLP chip 38 to focus the infrared radiation toward the target hair 44. It will be appreciated that there may be embodiments where the lenses 40,42 are not required, or where more or fewer lenses are required.

The guide mechanism 100 of FIG. 2 may be beneficial in that any stray radiation from a pixel of the DLP chip 38 may comprise only a small proportion of the overall power of the emitted infrared radiation.

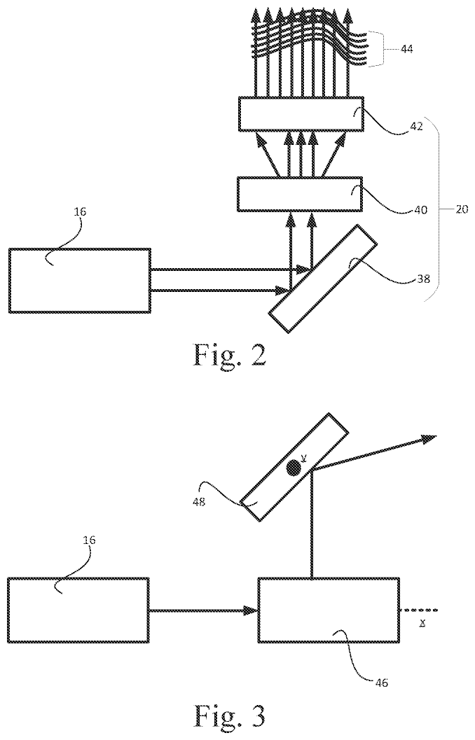

A second example of a possible guide mechanism 200 is illustrated in FIG. 3.

Here the guide mechanism 200 comprises first 46 and second 48 mirrors. The first mirror 46 is rotatable about a first “X” axis, and the second mirror 48 is rotatable about a second “Y” axis orthogonal to the first “X” axis. Each mirror 46,48 is rotatable by a respective motor or galvanometer 50,52 to direct infrared radiation from the laser light source toward target hair 54. Such a configuration of mirrors may be similar to that used in laser scanning.

The guide mechanism 200 of FIG. 3 may require a relatively high-power in view of the scanning nature of the laser.

In the embodiments of FIGS. 1-3 the heat source 16 is a laser heat source, and the embodiments of the guide mechanism 20 utilise optical elements such as mirrors and lenses to reflect and refract emitted radiation to guide the radiation toward the target hair. Alternative embodiments that utilise a different heat source 16 and a different guide mechanism are also envisaged.

For example, the heat source 16 may instead comprise a convective heat source that is configured to heat airflow flowing through the housing 12, with the heated airflow then being provided via the air outlet 32 in the manner of a typical hair dryer. In such an embodiment the air outlet 32 may comprise a variable air outlet, for example an air outlet that can be selectively occluded by a movable mechanical member, to guide the heated airflow toward the location of target hair determined by the location determination module 18, or the guide mechanism 20 may comprise a movable baffle or the like to direct airflow from the air outlet toward the location of target hair determined by the location determination module 18.

In the embodiments described herein, the haircare appliance 10 may also comprise a controller configured to control the airflow generator 14 and/or the heat source 16, for example in response to an output of the location determination module 18. This may enable automatic control of the airflow generator 14 and/or the heat source 16 in response to the location of target hair determined by the location determination module 18. In some embodiments the controller may control the airflow generator 14 and/or the heat source 16 such that the airflow generator 14 and/or the heat source 16 is inoperable where the location determination module 18 does not detect the presence of hair in use.

The controller for the airflow generator 14 and/or the heat source 16 may be part of a larger controller for the haircare appliance, for example the controller 22 that also controls the guide mechanism 20, or alternatively separate controllers may be provided for each of the airflow generator 14, the heat source 16, and the guide mechanism 20.

In the embodiment of FIG. 1 above the location determination module 18 is described as comprising a thermal imaging sensor 34 and a processor 36. It will be appreciated that additional and/or alternative components of the location determination module 18 are envisaged provided that the location determination module 18 is configured to determine a location of target hair.

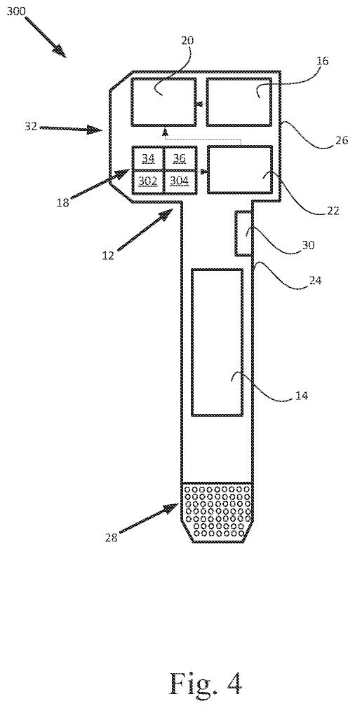

A haircare appliance 300 with additional location determination module 18 components is illustrated schematically in FIG. 4, where the location determination module 18 comprises a visible light imaging sensor 302 in the form of a video camera, and an image classifier 304. The visible light imaging sensor 302 captures images in use, and the image classifier 304 processes captured images to determine the location of target hair, for example by determining the location of wet hair in a captured image. Use of a visible light imaging sensor may enable determination of a location of target hair where temperature differentials between target hair and non-target hair, or target hair and ambient objects, are relatively small, and so may complement or replace the functionality of the thermal imaging sensor 34 discussed above.

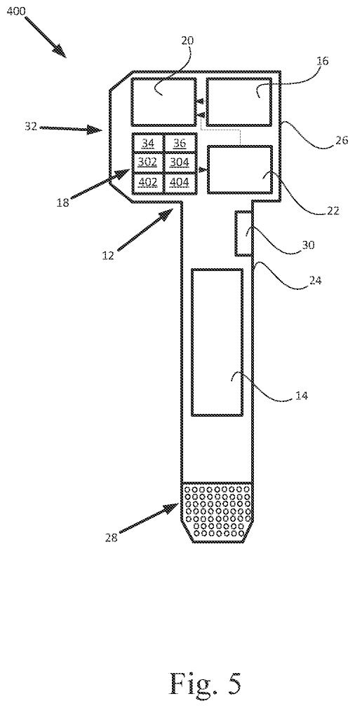

A further haircare appliance 400 with additional location determination module 18 components is illustrated schematically in FIG. 5, where the location determination module 18 comprises a temperature sensor 402 and a moisture sensor 404. By sensing a surface temperature and/or moisture content of hair a more accurate determination of a location of target, for example wet, hair may be made.

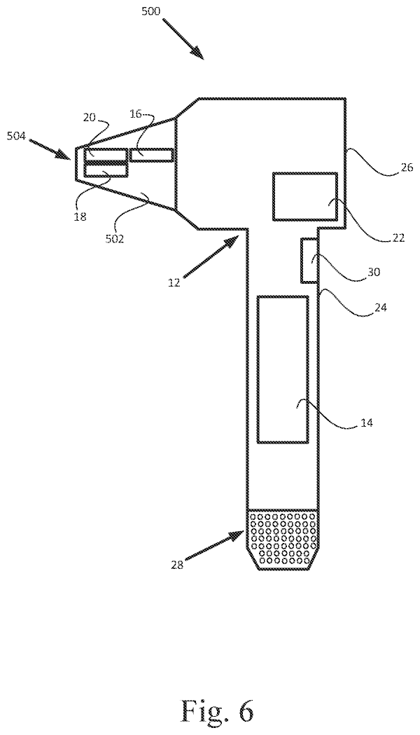

In the embodiments of FIGS. 1, 4 and 5, the heat source 16, the location determination module 18, and the guide mechanism 20 are disposed in the body portion 26 of the housing 12. An alternative embodiment of a haircare appliance 500 is illustrated schematically in FIG. 6, where the haircare appliance 500 comprises an attachment 502 releasably attached to the housing 12. The attachment 502 may be releasably attached in any appropriate manner, including, for example magnetic attachment. The heat source 16, the location determination module 18, and the guide mechanism 20 are illustrated as being disposed in the attachment 502, but it will be recognised that any appropriate combination of the aforementioned components may be housed in the attachment 502 in practice.

By locating any combination of the heat source 16, the location determination module 18, and the guide mechanism 20 in the attachment 502, the functionality discussed above, where the location determination module 18 determines a location of target hair, and the guide mechanism 20 guides heat emitted by the heat source 16 toward the determined location of target hair, may be selectively provided, and indeed may be retrofitted onto an existing haircare appliance.

It will be appreciated that the attachment 502 may communicated with the remainder of the haircare appliance 10, for example with appropriate wired or wireless communication as needed.

The attachment 502 receives airflow from the air outlet 32, and provides the airflow to the target hair via its own air outlet 504.

In the above described embodiments, the guide mechanisms comprise mechanical members which move to physically guide emitted radiation to the location of target hair. In alternative embodiments, the guide mechanism is configured to provide a visual and/or aural indicia to a user, for example a visual and/or aural indicia that directs a user to move the haircare appliance such that heat from the heat source 16 is guided toward the location of target hair, in response to the output of the location determination module 18. The guide mechanism comprises any of a light, a display, or a speaker in such embodiments.

In each embodiment described herein, the heat source 16, the location determination module 18, and the guide mechanism 20 are utilised to guide heat toward an identified location of target hair, which may provide more efficient drying with less wasted power than, for example, a haircare appliance where heat is simply directed in the general vicinity of hair by motion of the haircare appliance by a user.

1. A haircare appliance comprising a heat source configured to emit heat, a location determination module configured to determine a location of target hair, and a guide mechanism for use in guiding emitted heat from the heat source to the location of the target hair in response to an output of the location determination module.

2. The haircare appliance as claimed in claim 1, wherein the guide mechanism comprises a movable member movable in response to the output of the location determination module.

3. The haircare appliance as claimed in claim 1, wherein the heat source comprises an infrared emitter configured to emit infrared radiation.

4. The haircare appliance as claimed in claim 3, wherein the guide mechanism comprises an optical element configured to interact with infrared radiation emitted by the infrared emitter.

5. The haircare appliance as claimed in claim 4, wherein the infrared emitter is configured to emit infrared radiation in a first direction, and the optical element is configured to interact with the emitted infrared radiation such that infrared radiation downstream of the optical element travels in a second direction different to the first direction.

6. The haircare appliance as claimed in claim 4, wherein the optical element comprises a plurality of mirrors.

7. The haircare appliance as claimed in claim 4, wherein the guide mechanism comprises a further optical element, the further optical element configured to refract the infrared radiation.

8. The haircare appliance as claimed in claim 1, wherein the location determination module comprises an imaging sensor configured to capture an image, and an image processor configured to determine the location of the target hair within the captured image.

9. The haircare appliance as claimed in claim 8, wherein the imaging sensor comprises at least one of a thermal imaging sensor and a visible light imaging sensor.

10. The haircare appliance as claimed in claim 1, wherein the location determination module comprises a hair sensor configured to determine a property of hair, and the location determination module is configured to process an output of the hair sensor to determine the location of the target hair.

11. The haircare appliance as claimed in claim 10, wherein the hair sensor comprises at least one of a temperature sensor for sensing a surface temperature of hair and a moisture sensor for sensing a moisture level of hair.

12. The haircare appliance as claimed in claim 10, wherein the haircare appliance comprises a controller configured to control the heat source in response to an output of the hair sensor or an output of the location determination module.

13. The haircare appliance as claimed in claim 1, wherein the heat source comprises a laser light source.

14. The haircare appliance as claimed in claim 1, wherein the heat source is configured to be inoperable when the location determination module cannot determine a location of target hair.

15. The haircare appliance as claimed in claim 1, wherein the haircare appliance comprises an airflow generator configured to generate an airflow directed toward the determined location of the target hair.

16. The haircare appliance as claimed in claim 1, wherein the haircare appliance comprises a main body, and an attachment releasably attached to the main body, the attachment comprising any of the heat source, the location determination module, or the guide mechanism.

17. An attachment for a haircare appliance, the attachment comprising a heat source configured to emit heat, a location determination module configured to determine a location of target hair, and a guide mechanism for use in guiding emitted heat from the heat source to the location of the target hair in response to an output of the location determination module.
